(19) United States
(12) Patent Application Publication
(10) Pub. No.: US 2018/0047948 A1
(43) Pub. Date: Feb. 15, 2018

(54) BATTERY CELL

(71) Applicant: Robert Bosch GmbH, Stuttgart (DE)

(72) Inventor: Markus Kohlberger, Stuttgart (DE)

(21) Appl. No.: 15/551,098

(22) PCT Filed: Feb. 15, 2016
(86) PCT No.: PCT/EP2016/053104

§ 371 Date: Aug. 15, 2017

(30) Foreign Application Priority Data
Feb. 18, 2015 (DE) 10 2015 202 894.1

(51) Int. Cl. H01M 2/04; H01M 2/06

(52) U.S. Cl. CPC H01M 2/043; H01M 2/06; H01M 2/0486; H01M 2220/20; H01M 10/0525

(57) ABSTRACT

The invention relates to a battery cell (2) which comprises a film-type covering (4) and at least one electrode unit (10) with two electrodes, namely a cathode and an anode, arranged inside said covering (4). A frame part (30) is arranged inside the covering (4) and surrounds the electrode unit (10) at least to some extent.

### BACKGROUND OF THE INVENTION

The invention relates to a battery cell, which comprises a covering configured in the manner of a film and at least one electrode unit, which is arranged inside the covering and has two electrodes, namely a cathode and an anode.

It is becoming apparent that in the future, both in static applications such as wind power systems, in motor vehicles which are configured as hybrid vehicles or electrical motor vehicles, and in electronic devices such as laptops or cell phones, new battery systems will be used which will be subject to very great demands in terms of reliability, safety, performance and lifetime.

In this case, in particular, so-called lithium-ion battery cells are used. These are distinguished inter alia by high energy densities, thermal stability and an extremely low self-discharge. Lithium-ion battery cells have a positive electrode and a negative electrode, at which lithium ions can reversibly accumulate and be released again during a charging process and during a discharging process. Such processes are also referred to as intercalation and deintercalation, respectively. One further development of lithium-ion battery cells involves battery cells with a post-lithium-ion technology, for example lithium-sulfur or lithium-air.

A battery cell generally comprises one or more electrode units. An electrode unit comprises two electrodes configured in the manner of a film, namely a cathode and an anode. The electrodes are, for example, wound with the interposition of a separator to form an electrode winding, which is also referred to as a jelly roll. The electrodes may also be placed flat on one another with the interposition of a separator in the form of an electrode stack. The two electrodes of the electrode winding and of the electrode stack are electrically connected by means of two collectors to two poles of the battery cell, which are also referred to as electrical terminals.

Different designs for battery cells are known. For example, a battery cell has a cell housing shaped in the form of a prism, particularly in the form of a cuboid, which is for example made of aluminum and configured to be pressure-resistant. The electrode unit is arranged inside the cell housing. Battery cells having a cell housing shaped in the form of a circular cylinder are also known.

Furthermore, battery cells having a covering configured in the manner of a film are known. An electrode unit having two electrodes is arranged inside the covering. The film-like covering is, for example, a laminated aluminum film and has a thickness of from 100 micrometers to 150 micrometers. After introduction of the electrode unit into the covering, air present therein is sucked out by means of reduced pressure and the covering is welded.

A battery cell of the species is disclosed, for example, in DE 102 25 041 A1. The battery cell comprises an electrode unit, which is enclosed by a film. The collectors of the electrode unit are in this case covered by means of an additional plastic film.

U.S. 2009/0286150 A1 discloses a relatively flatly configured battery cell, which has a protective frame. The protective frame is formed in two parts, and in particular increases the mechanical stability of the battery cell.

WO 95/29513 A1 discloses a frame design for an electrode unit of a battery cell. Stiff individual walls are provided, which are arranged around the electrode unit and, for example, are connected by means of an adhesive tape.

### SUMMARY OF THE INVENTION

A battery cell is provided, which comprises a covering configured in the manner of a film and at least one electrode unit, which is arranged inside the covering and has two electrodes, namely a cathode and an anode.

According to the invention, a frame part, which at least partially encloses the electrode unit, is arranged inside the covering.

The electrode unit is, for example, configured as an electrode stack and shaped approximately in the form of a prism, in particular approximately in the form of a cuboid.

The frame part advantageously prevents contact of edges of the electrode unit with the covering.

Preferably, the frame part has four side walls, which enclose the electrode unit.

According to one advantageous configuration of the invention, at least one side wall of the frame part has a recess for feeding through a collector of the electrode unit.

The frame part is preferably configured in one piece.

Particularly preferably, the frame part is configured in the form of a trough.

According to one advantageous refinement of the invention, outwardly pointing edges of the frame part are rounded or chamfered.

According to another advantageous configuration of the invention, the frame part comprises a spring element, which is arranged between a surface of the electrode unit and the covering.

A battery cell according to the invention is advantageously used in an electrical vehicle (EV), in a hybrid vehicle (HEV), or in a plug-in hybrid vehicle (PHEV).

In a battery cell configured according to the invention, the frame part reliably prevents damage to the electrode unit. The electrodes and the separator, which in battery cells with post-lithium-ion technology is preferably made of ceramic, are relatively hard and brittle and therefore susceptible to damage by pressure. In particular, in a battery cell configured according to the invention the edges of the electrode unit are protected against mechanical damage. Short circuits and other defects, which may result from such damage, are therefore avoided.

The frame part also protects the electrode unit in the event of a volume change. Electrode units in battery cells with post-lithium-ion technology experience such a volume change between a fully charged state and a discharged state. The electrode unit expands during a charging process.

The frame part also prevents damage to the covering by the edges of the electrode unit. When, after introduction of the electrode unit into the covering, the air present therein is sucked out by means of reduced pressure, contact of the sometimes sharp edges of the electrode unit with the covering is prevented.

The frame part can be produced economically. Mounting of the electrode unit in the frame part and mounting of the frame part in the covering are also relatively simple and not elaborate. The material costs and the assembly costs of the battery cell are therefore increased only insubstantially. The frame part also has only a relatively small space requirement. The volume of the battery cell is therefore increased only insubstantially by the frame part.

### BRIEF DESCRIPTION OF THE DRAWINGS

Embodiments of the invention will be explained in more detail with the aid of the drawings and the description below.

FIG. 1 shows a perspective representation of a battery cell,

FIG. 2 shows a perspective representation of a frame part for a battery cell,

FIG. 3 shows a section through a frame part for a battery cell according to a variant,

FIG. 4 shows an electrode unit of a battery cell, and

FIG. 5 shows a section through a battery cell.

### DETAILED DESCRIPTION

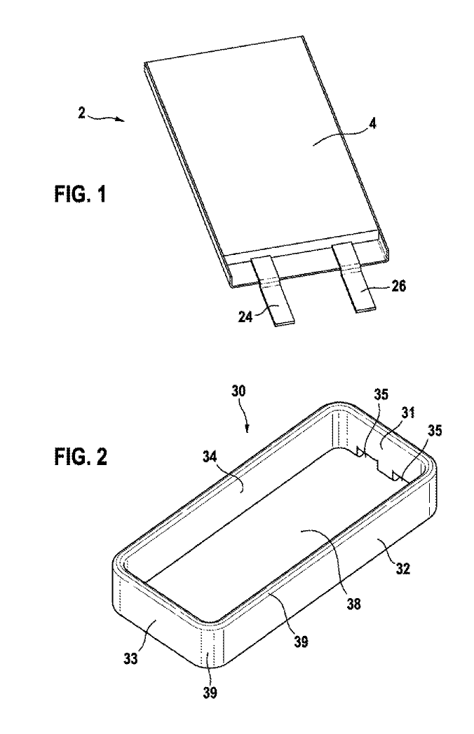

FIG. 1 represents a battery cell in perspective. The battery cell 2 comprises a covering 4 configured in the manner of a film, inside which an electrode unit 10, which cannot be seen in this representation, is arranged. The electrode unit 10 comprises a cathode and an anode, as well as a first collector 24 and a second collector 26. The anode is electrically connected to the first collector 24, and the cathode is electrically connected to the second collector 26. The collectors 24, 26 extend out of the covering 4 through openings in the covering 4, which are intended for this purpose, and are externally accessible and electrically contactable.

The covering 4 is a laminated aluminum film. The covering 4 in the present case has a thickness of between 100 μm and 150 μm. Of course, the covering 4 may also be made of another material and have a different thickness.

The electrode unit 10 comprises a plurality of unit cells, each unit cell comprising a cathode configured in the form of a plate and an anode configured in the form of a plate. A separator configured in the form of a plate is provided between the cathode configured in the form of a plate and the anode configured in the form of a plate. A plurality of such unit cells are arranged flat on one another to form an electrode stack and form the electrode unit 10.

A cathode contact lug respectively extends away from each cathode configured in the form of a plate. Likewise, an anode contact lug extends away from each anode configured in the form of a plate. The cathode contact lugs of each unit cell are connected with a material fit, in particular welded, to one another and to the first collector 24. Likewise, all the anode contact lugs of all the unit cells are connected with a material fit, in particular welded, to one another and to the second collector 26.

The electrode unit 10 is enclosed by a frame part 30, which likewise cannot be seen in this representation. The frame part 30 and the electrode unit 10 therefore lie inside the covering 4. During manufacture of the battery cell 2, the frame part 30 is introduced together with the electrode unit 10 into the covering 4. The air present in the covering 4 is then sucked out, and the covering 4 is then welded and sealed in an airtight fashion. The frame part 30 prevents, in particular, contact of edges of the electrode unit 10 with the covering 4.

FIG. 2 represents a frame part 30 for a battery cell 2 in perspective. The frame part 30 comprises a first side wall 31, a second side wall 32, a third side wall 33 and a fourth side wall 34. The frame part 30 is made for example of polyethylene, polypropylene, polyethylene terephthalate, polyimide or polyphenylene sulfide. Combinations or mixtures of the aforementioned materials may also be envisioned.

The four side walls 31, 32, 33, 34 of the frame part 30 are arranged in such a way that the frame part 30 is shaped approximately in the form of a cuboid. The first side wall 31 lies opposite the third side wall 33. Likewise, the second side wall 32 lies opposite the fourth side wall 34. The first side wall 31 and the third side wall 33 extend parallel to one another. The second side wall 32 and the fourth side wall 34 likewise extend parallel to one another. The first side wall 31 and the third side wall 33 extend approximately perpendicularly to the second side wall 32 and the fourth side wall 34.

In the present case, the side walls 31, 32, 33, 34 have a wall thickness of about 0.5 mm. Other wall thicknesses may also be envisioned, in particular between 0.25 mm and 1 mm. The four side walls 31, 32, 33, 34 enclose a free space 38, which is used to receive the electrode unit 10 (not represented in FIG. 2).

Two recesses 35 are provided in the first side wall 31. The free space 38 is shaped approximately in the form of a cuboid, and as already mentioned is used to receive the electrode unit 10. The recesses 35 are used for feeding the first collector 24 as well as the second collector 26 out of the free space 38.

In the present case, the frame part 30 is configured in one piece. This means that the side walls 31, 32, 33, 34 are integrally connected to one another. A multi-part configuration of the frame part 30 may likewise be envisioned, with separate side walls 31, 32, 33, 34.

The frame part 30 has edges 39, which point outward. The edges 39 of the drain part 30 are rounded or chamfered. This means that the edges 39 of the frame part 30, in particular, not sharply or pointedly configured. This prevents the edges 39 of the frame part 30 from damaging the covering 4 of the battery cell 2.

As an alternative, it is conceivable to configure the frame part 30 in the form of a trough. In this case, besides the four side walls 31, 32, 33, 34, the frame part 30 also comprises a bottom surface, on which the electrode unit 10 then rests and is laterally enclosed by the four side walls 31, 32, 33, 34.

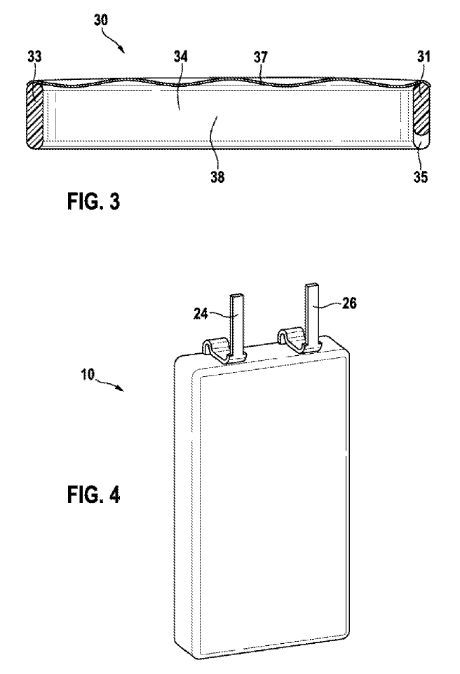

A section through a frame part 30 for a battery cell 2 according to a variant is represented in FIG. 3. The frame part 30 comprises a spring element 37, is connected to the first side wall 31, the second side wall 32, the third side wall 33 and the fourth side wall 34. The spring element 37 thus covers a surface of the frame part 30 at least almost fully.

In the state installed in the battery cell 2, the spring element 37 is arranged between a surface of the electrode unit 10 and the covering 4. The spring element 37 therefore induces a force between the covering 4 and the electrode unit 10, and therefore eliminates play possibly existing in the battery cell 2.

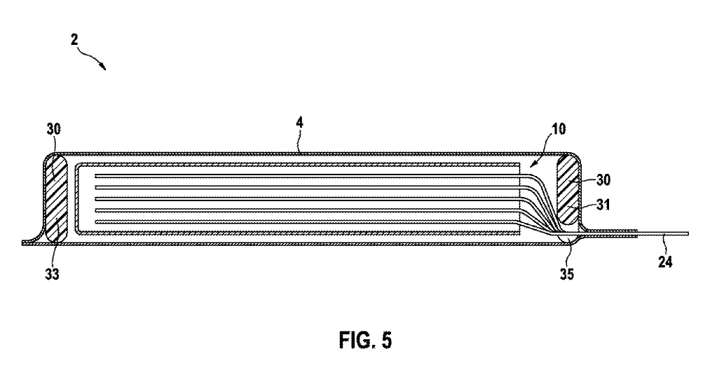

An electrode unit 10 of a battery cell 2 is represented in perspective in FIG. 4. As already mentioned, the electrode unit 10 is configured as an electrode stack and comprises a plurality of unit cells, which respectively comprise a cathode configured in the form of a plate and an anode configured in the form of a plate, which are respectively separated from one another by a separator configured in the form of a plate.

The electrode unit 10 is shaped in the form of a prism, in the present case in the form of a cuboid. The first collector 24 and the second collector 26 extend away from an end surface of the electrode unit 10. The electrode unit 10 has dimensions corresponds approximately to those of the free space 38 of the frame part 30. The electrode unit 10 thus fills the free space 38 of the frame part 30 approximately fully.

A section through a battery cell 2 is represented in FIG. 5. The covering 4 encloses the frame part 30 and the electrode unit 10. The collectors 24 and 26, of which only the first collector 24 can be seen in the representation shown, extend through the recesses 35 which are provided in the first side wall 31 of the frame part 30.

The electrode unit 10 is arranged approximately entirely between the first side wall 31 and the third side wall 33. Likewise, the electrode unit 10 is arranged entirely between the second side wall 32 (not represented here) and the fourth side wall 34 (likewise not represented).

As can be seen from the representation shown in FIG. 5, the side walls 31, 33, as well as the side walls 32, 34 (which cannot be seen), are slightly larger than the thickness of the electrode unit 10. This means that the side walls 31, 32, 33, 34 extend further than the electrode unit 10 in at least one direction. The electrode unit 10 is therefore enclosed fully by the side walls 31, 32, 33 and 34. In particular, contact of edges of the electrode unit 10 with the covering 4 is therefore prevented.

The electrode unit 10 may be fixed by additional means, for example with a force fit and/or form fit, in the free space 38 of the frame part 30. For example, matching resilient spacers may be fitted between the electrode unit 10 and at least one of the side walls 31, 32, 33, 34.

Fixing of the electrode unit 10 in the free space 38 of the frame part 30 by means of adhesive may, however, be envisioned. A resilient adhesive, which is produced for example on the basis of acrylic or on the basis of silicone, is in particular suitable for this. The adhesive may in this case fill immediate spaces which remain between the electrode unit 10 and at least one of the side walls 31, 32, 33, 34, and therefore fix the electrode unit 10 inside the frame part.

The invention is not restricted to the exemplary embodiments described and the aspects highlighted therein. Rather, many variants which lie within the scope of the business of the person skilled in the art are possible within the range justified by the claims.

1. A battery cell (2), comprising
a covering (4) configured in the manner of a film,
at least one electrode unit (10), which is arranged inside the covering (4) and has two electrodes, namely a cathode and an anode, and
a frame part (30), which at least partially encloses the electrode unit (10), inside the covering (4).

2. The battery cell (2) as claimed in claim 1, characterized in that the electrode unit (10) is configured as an electrode stack and shaped approximately in the form of a prism.

3. The battery cell (2) as claimed in claim 1, characterized in that the frame part (30) prevents contact of edges of the electrode unit (10) with the covering (4).

4. The battery cell (2) as claimed in claim 1, characterized in that the frame part (30) has four side walls (31, 32, 33, 34), which enclose the electrode unit (10).

5. The battery cell (2) as claimed in claim 4, characterized in that at least one side wall (31) of the four side walls has at least one recess (35) for feeding through a collector (24, 26) of the electrode unit (10).

6. The battery cell (2) as claimed in claim 1, characterized in that the frame part (30) is configured in one piece.

7. The battery cell (2) as claimed in claim 1, characterized in that the frame part (30) is configured in the form of a trough.

8. The battery cell (2) as claimed in claim 1, characterized in that outwardly pointing edges (39) of the frame part (30) are rounded or chamfered.

9. The battery cell (2) as claimed in claim 1, characterized in that the frame part (30) comprises a spring element (37), which is arranged between a surface of the electrode unit (10) and the covering (4).

10. (canceled)

11. The battery cell (2) as claimed in claim 1, characterized in that the electrode unit (10) is configured as an electrode stack and shaped approximately in the form of a cuboid.

12. A vehicle comprising a battery cell (2) as claimed in claim 1.

13. The vehicle as claimed in claim 12, wherein the vehicle is an electrical vehicle (EV), a hybrid vehicle (HEV), or a plug-in hybrid vehicle (PHEV).
